(19) United States
(12) Patent Application Publication
(10) Pub. No.: US 2004/0110898 A1
(43) Pub. Date: Jun. 10, 2004

(54) Method for producing capsules containing an active ingredient and having an ultra-thin coating

(76) Inventors: Michael Dreja, Koeln (DE); Wolfgang von Rybinski, Duesseldorf (DE); Matthias Hof, Duisburg (DE); Herbert Leonhard, Bottrop (DE); Heinz Rehage, Essen (DE)

Correspondence Address: HENKEL CORPORATION, THE TRIAD, SUITE 200, 2200 RENAISSANCE BLVD., GULPH MILLS, PA, 19406, US

(21) Appl. No.: 10/312,790

(22) PCT Filed: Jun. 23, 2001
(86) PCT No.: PCT/EP01/07157

(30) Foreign Application Priority Data
Jun. 30, 2000 (DE) 100 31 132.6

(51) Int. Cl. C08L 1/00

(52) U.S. Cl. 524/839

(57) ABSTRACT

A method for producing polymer capsules, pellets or droplets containing an active ingredient and having an ultra-thin coating is described, in which the active ingredient present in a dispersion with aqueous and organic phase is encapsulated in situ by means of heat-, plasma- or radiation-induced free-radical interfacial polymerization.

The present invention relates to a method for producing diffusion-tight polymer capsules, pellets or droplets containing an active ingredient and having an ultra-thin coating by means of interfacial polymerization, and to the use of the capsules, pellets or droplets produced in this way as delivery systems for active ingredients, in particular for use in cosmetic products, pharmaceutical compositions, adhesives, detergents and cleaners and the like.

Active substances, such as fragrances, essential oils, perfume oils and care oils, dyes or pharmaceutically active ingredients which are used in cosmetic and/or pharmaceutical products or in detergents and cleaners often lose their activity during storage and also directly upon use. Some of these substances can also have insufficient stability for use or cause troublesome interactions with other product constituents.

It is therefore of interest to use such substances in a controlled manner and at the desired site of use with maximum effect.

For this reason, active substances, such as fragrances, care oils and antibacterial active ingredients are added to the products in spatially delimited, protected form. Sensitive substances are often enclosed in capsules of varying sizes, absorbed to suitable carrier materials or chemically modified. Release can then be activated using a suitable mechanism, for example mechanically by shearing, or take place by diffusion directly from the matrix material.

Systems are therefore sought which are suitable as encapsulation, transportation or administration vehicles—often also referred to as delivery systems or carrier systems.

There are already numerous commercial delivery systems which are based on porous polymer particles or liposomes (e.g. Mikrosponges® from Advanced Polymer Systems and also Nanotopes® from Ciba-Geigy, see in this respect B. Herzog, K. Sommer, W. Baschong, J. Röding “Nanotopes™: A Surfactant Resistant Carrier System” in SÖFW-Journal, 124th volume 10/98, pages 614 to 623).

The disadvantage of these conventional delivery systems known from the prior art is that they have only a low charge potential, the particle size of the polymer pellets is in most cases in the range from a few micrometers to a few 100 μm, and encapsulation of the active substances can generally not be carried out in situ. Modification of the capsule surfaces is not possible or very complex. Liposomes also have an inadequate stability for many applications.

The object of the present invention is therefore to provide a method of producing polymeric capsules, pellets or droplets having an ultra-thin coating which are suitable as carriers for active ingredients which are very diverse in nature.

In particular, using such a method it should be possible to produce capsules, pellets or droplets which can be used as delivery systems for said active ingredients and thus ensure controlled release of these active ingredients at the desired site.

The ultra-thin coatings of the capsules, pellets or droplets produced should be as diffusion-tight as possible toward the enclosed active substance. In addition, the encapsulation should prevent coagulation, agglomeration or uncontrolled diffusion of the enclosed active ingredients and also permit their controlled release.

The capsules, pellets or droplets produced by the method according to the invention should also have the greatest possible charge potential.

Furthermore, the method should permit, through the choice of the production parameters, in particular the starting materials used and the reaction conditions, a targeted control (“tailoring”) of the properties of the polymeric capsules, pellets or droplets produced.

The problem which forms the basis of the present invention is solved by a method for producing polymer capsules, pellets or droplets containing an active ingredient and having an ultra-thin coating, in which

(a) firstly a dispersion is prepared which comprises at least one active ingredient to be encapsulated or enclosed and, starting from which, polymers can be formed by free-radical interfacial polymerization;

(b) then a heat-, plasma- or radiation-induced (e.g. by light, such as laser light, by X-ray radiation, by γ-radiation, etc.) free-radical interfacial polymerization is carried out in the dispersion obtained in step (a), such that, in this way, an in situ encapsulation or an in situ enclosure of the at least one active ingredient into the polymer capsules, pellets or droplets produced by interfacial polymerization takes place; and

(c) finally the polymer capsules, pellets or droplets containing an active ingredient obtained in this way can, if required, be separated off.

The present invention provides in particular a method for producing polymer capsules, pellets or droplets containing an active ingredient and having an ultra-thin coating which is characterized by the following steps:

(a) provision of a dispersion comprising:

at least one interfacially active (surface-active, amphiphilic) monomer,

at least one active ingredient to be encapsulated or enclosed,

optionally at least one polymerization initiator (polymerization starter),

optionally at least one comonomer,

optionally at least one polymerization accelerator,

aqueous phase and

oil phase (organic phase);

(b) carrying out a heat-, plasma- or radiation-induced free-radical interfacial polymerization of the at least one surface-active (amphiphilic, interface-active) monomer in the presence of the at least one active ingredient and optionally the at least one polymerization initiator (polymerization starter), optionally the at least one comonomer and optionally the at least one polymerization accelerator at the phase interface between oil phase (organic phase) and aqueous phase, where, in this way, an in situ encapsulation or an in situ enclosure of the at least one active ingredient is effected;

(c) if required, separation of the polymer capsules, pellets or droplets containing an active ingredient obtained in this way off from the reaction mixture.

In step (a), a dispersion, preferably emulsion, is firstly prepared, which comprises at least one interface-active monomer (in the present description referred to synonymously also as “surface-active monomer” or “amphiphilic monomer”), at least one active ingredient (in the present description referred to synonymously also as “active substance”), optionally at least one polymerization initiator (in the present description referred to synonymously also as “polymerization starter”), optionally at least one comonomer and optionally at least one polymerization accelerator, where the dispersion comprises an aqueous phase and an oil phase.

This may either be an oil-in-water dispersion or oil-in-water emulsion or else a water-in-oil dispersion or water-in-oil-emulsion.

The production of such a dispersion is familiar to the person skilled in the art. A customary procedure for producing the dispersion involves firstly predissolving the active ingredient to be encapsulated or enclosed in the oil phase or in the water phase, and then adding the other above-mentioned dispersion constituents. Equally, it is possible to also predissolve one or more of the other constituents (e.g. including the interface-active monomer) together with the active ingredient in the oil phase or in the water phase, and then to add the aqueous phase or the oil phase.

After combining all of the components, the dispersion is produced from the starting mixture using customary methods or auxiliary means familiar to the person skilled in the art. For this purpose, it is possible, for example, to use suitable dispersion devices, such as, for example, ultrasound devices or other known dispersion devices for the emulsification, suspension and homogenization of flowable media (thus e.g. an Ultra-Turrax® from IKA-Maschinenbau). The method of producing the dispersion is not critical and is familiar to the person skilled in the art.

Equally, it is possible to produce the dispersion in a continuous process. This is particularly advantageous when the subsequent step (b) of the interfacial polymerization is likewise operated continuously. Such as procedure is likewise familiar to the person skilled in the art.

The dispersion time can vary within wide limits. It is generally about 0.5 to about 3 min.

By means of the production method of the dispersion (dispersion time, type and amount of energy introduced, such as ultrasound etc.), it is possible—in addition to other variable parameters, as described in more detail below—to control the average particle size in the dispersion and thus also the average particle size of the end product.

Optionally, further customary added substances or additives can be added to the dispersion, the choice of which is at the discretion of the person skilled in the art, thus e.g. surfactants, emulsifiers, bodying agents, thickeners, gel formers, stabilizers, swelling agents etc.

Oil phases (organic phases) which are suitable according to the invention and can be used for the dispersion are those organic materials and substances which are inert under the reaction conditions and do not impair the course of the reaction.

Examples of oil phases suitable according to the invention are higher, linear or branched, saturated or unsaturated, aliphatic, alicyclic or aromatic hydrocarbons, in particular those with more than 6 carbon atoms, preferably those with more than 10 carbon atoms, or mixtures of such hydrocarbons.

Examples of such hydrocarbons are aliphatic C₁₀-C₂₂-hydrocarbons, such as decane, undecane, dodecane, tridecane, tetradecane, pentadecane, hexadecane, heptadecane, octadecane, nonadecane and eicosane. Likewise suitable according to the are the hydrocarbons tricyclodecane and decalin. Furthermore, squalane and squalene can, for example, also be used as hydrocarbons suitable according to the invention.

Suitable as oil phase according to the invention are, for example, also Guerbet alcohols based on fatty alcohols having 6 to 18 carbon atoms, preferably 8 to 10 carbon atoms, esters of linear C₆-C₂₂-fatty acids with linear C₆-C₂₂-fatty alcohols, esters of branched C₆-C₁₃-carboxylic acids with linear C₆-C₂₂-fatty alcohols, such as, for example, myristyl myristate, myristyl palmitate, myristyl stearate, myristyl isostearate, myristyl oleate, myristyl behenate, myristyl erucate, cetyl myristate, cetyl palmitate, cetyl stearate, cetyl isostearate, cetyl oleate, cetyl behenate, cetyl erucate, stearyl myristate, stearyl palmitate, stearyl stearate, stearyl isostearate, stearyl oleate, stearyl behenate, stearyl erucate, isostearyl myristate, isostearyl palmitate, isostearyl stearate, isostearyl isostearate, isostearyl oleate, isostearyl behenate, isostearyl oleate, oleyl myristate, oleyl palmitate, oleyl stearate, oleyl isostearate, oleyl oleate, oleyl behenate, oleyl erucate, behenyl myristate, behenyl palmitate, behenyl stearate, behenyl isostearate, behenyl oleate, behenyl behenate, behenyl erucate, erucyl myristate, erucyl palmitate, erucyl stearate, erucyl isostearate, erucyl oleate, erucyl behenate and erucyl erucate. Also suitable are esters of linear C₆-C₂₂-fatty acids with branched alcohols, in particular 2-ethylhexanol, esters of hydroxycarboxylic acids with linear or branched C₆-C₂₂-fatty alcohols, in particular dioctyl malates, esters of linear and/or branched fatty acids with polyhydric alcohols (such as e.g. propylene glycol, dimerdiol or trimertriol) and/or Guerbet alcohols, triglycerides based on C₆-C₁₀-fatty acids, liquid mono-/di-/triglyceride mixtures based on C₆-C₁₈-fatty acids, esters of C₆-C₂₂-fatty alcohols and/or Guerbet alcohols with aromatic carboxylic acids, in particular benzoic acid, esters of C₂-C₁₂-dicarboxylic acids with linear or branched alcohols having 1 to 22 carbon atoms or polyols having 2 to 10 carbon atoms and 2 to 6 hydroxyl groups, vegetable oils, branched primary alcohols, substituted cyclohexanes, linear and branched C₆-C₂₂-fatty alcohol carbonates, Guerbet carbonates, esters of benzoic acid with linear and/or branched C₆-C₂₂-alcohols, linear or branched, symmetrical or asymmetrical dialkyl ethers having 6 to 22 carbon atoms per alkyl group, ring-opening products of epoxidized fatty acid esters with polyols and/or silicone oils.

The oil phase generally serves as an organic carrier phase for the active ingredients to be encapsulated or enclosed. In some instances, the water phase may also serve as carrier phase for the active ingredients, namely in the case of active ingredients which are not soluble in the organic carrier phase.

According to a particular embodiment, if the active ingredient to be encapsulated or enclosed is itself an oil phase, i.e. the active ingredient to be encapsulated or enclosed is an organic oily body, the dispersion can also be produced without additional oil phase. However, in such a case it is also entirely possible to use, in addition to the active ingredient to be encapsulated or enclosed present in the form of an oily body, an additional oil phase, which serves as organic carrier phase for the active ingredient, for producing the dispersion.

The aqueous phase used is conventional (mains) water or else deionized water. Preference is given to deionized water. To control and adjust the density of the aqueous phase, added substances or additives, such as, for example salts, can be added to the aqueous phase in a targeted manner.

The production of the dispersion in step (a) is followed by step (b). In step (b), the interface-active monomer is subjected, in the presence of the active ingredient to be encapsulated or enclosed and optionally in the presence of the polymerization initiator and optionally in the presence of the comonomer and optionally in the presence of the polymerization accelerator, to a free-radical interfacial polymerization at the interface between oil phase and aqueous phase. The interfacial polymerization usually takes place with heat, plasma or radiation induction, preferably light induction, especially with UV irradiation.

As mentioned above, the interfacial polymerization according to step (b) can either be carried out discontinuously (e.g. as a batch process) or else continuously.

The method of interfacial polymerization is known per se and has been used for a long time. Reference may be made, for example, to the overview article by B. Tieke “Polymerization at Interfaces” in Polym. Organ. Media 1992, page 105 to 181, edited by C. M. Paleos Publisher: Gordon and Breach, Philadelphia, the entire contents of which are hereby incorporated by reference. Furthermore, reference is made to the literature cited in the review article. In general, interfacial polymerization can be defined as a polymerization which takes place in the interfaces between two liquids which are immiscible with one another.

The free-radical interfacial polymerization in step (b) of the process according to the invention achieves an in situ encapsulation or an in situ enclosure of the active ingredient, such that, when the polymerization reaction is complete, polymer capsules, pellets or droplets containing an active ingredient and having an ultra-thin coating are formed which enclose and contain the active ingredient in a polymer matrix.

As mentioned above, the polymerization in step (b) proceeds with heat, plasma and/or radiation induction, in particular light induction. If the interfacial polymerization takes place with light induction, the irradiation times and the irradiation intensities can vary within a wide range. In general, the irradiation times in this case are from about 5 to about 60 min. The irradiation intensities are about 5 to about 30 mW/m².

It has been found that light-induced free-radical polymerization is particularly suitable for crosslinking corresponding monomers at the interface between oil and water. To initiate the reaction, a low-pressure mercury vapor lamp (e.g. of the type OSRAM HNS 10 W/U ORF), for example, can be used. Such lamps are generally characterized by a high photon yield, a very precise emission spectrum at a wavelength λ=254 nm and a very low radiation of heat. In general, the irradiation maxima are about 254 nm.

As already detailed above, plasma-induced interfacial polymerization is also suitable according to the invention. For this, a low temperature plasma from a microwave reactor or else a glow discharge plasma, for example, can be used. For plasma induction, it is possible to use, for example, a HF generator with 3.5 MHz. The plasma may be an argon plasma which is ignited, for example, at 400 to 1000 Hpa, where the temperature in the reaction zone is 10000 K. Suitable, for example, is an N₂ mixing chamber with quenching pipes. For further details relating to plasma induction, reference may be made to F. Sigenegar et al. in Plasma Chem. Plasma Process. 18 (1998), 153 and to M. Guo and A. Ohl in J. Phys. D. Appl. Phys. 31 (1998), 2018, the contents of which are hereby incorporated by reference.

The reaction temperature for the interfacial polymerization can vary within wide limits. It is generally between about 10° C. and about 100° C., preferably between about 20° C. and about 50° C.

The monomer concentration in the starting mixture can vary within wide limits. The monomer concentration in the starting mixture is generally about 5 to 60 mmol/l, preferably about 5 mmol/l to about 30 mmol/l, based on the starting mixture.

Interface-active (surface-active, amphiphilic) monomers suitable according to the invention are, in particular, chosen from the group of interface-active (surface-active, amphiphilic) (meth)acrylates, succinates and sulfonates, and derivatives thereof.

Examples of interface-active acrylates, succinates and sulfonates, and derivatives thereof, which are suitable according to the invention which can be mentioned are the following compounds: trimethylolpropane triacrylate (e.g.

Photomer® 4006, sold by Cognis GmbH Deutschland), trimethylolpropane ethoxylate triacrylate (e.g. Photomer® 4149, sold by Cognis GmbH Deutschland), trimethylolpropane propoxylate triacrylate (e.g. Photomer® 4072, sold by Cognis GmbH Deutschland), aliphatic urethane diacrylates (e.g.

Photomer® 6010, sold by Cognis GmbH Deutschland), aliphatic urethane triacrylates (e.g. Photomer® 6008, sold by Cognis GmbH Deutschland), dimerdiol dimethacrylate, dodecanediol-1,12 dimethacrylate, lauryl allyl sulfosuccinate (e.g. TREM-LF-40®), dodecyl-15 EO acrylate (e.g. Blemmer ALE 800®, sold by Nippon Oil & Fats Co., Ltd.), dodecyl-15 EO methacrylate (e.g. Blemmer PLE 800®, sold by Nippon Oil & Fats Co., Ltd.), octadecyl-15 EO methacrylate (e.g. Blemmer PSE 800®, sold by Nippon Oil & Fats Co., Ltd.), octadecyl-15 EO acrylate (e.g. Blemmer ASE 800®, sold by Nippon Oil & Fats Co., Ltd.), diallylammonium dodecylsulfonate, diallylsulfonium 2-hydroxydodecyl chloride, diallylsulfonium 2-hydroxytetradecyl chloride, diallylsulfonium 2-hydroxyhexadecyl chloride, polyethylene glycol monomethacrylate (e.g. Blemmer PE-Serie®, sold by Nippon Oil & Fats Co., Ltd.), polyethylene glycol monoacrylate (e.g. Blemmer AE-Serie®, sold by Nippon Oil & Fats Co., Ltd.), polypropylene glycol monomethacrylate (e.g. Blemmer PP-Serie®, sold by Nippon Oil & Fats Co., Ltd.), polypropylene glycol monoacrylate (e.g. Blemmer AP-Serie®, sold by Nippon Oil & Fats Co., Ltd.), polyethylene glycol polypropylene glycol monomethacrylate (e.g. Blemmer PEP-Serie®, sold by Nippon Oil & Fats Co., Ltd.), polyethylene glycol polypropylene glycol monoacrylate (e.g. Blemmer AEP-Serie®, sold by Nippon Oil & Fats Co., Ltd.) and mixtures thereof.

Further interface-active monomers suitable according to the invention and their synthesis and characterization are described, for example, by P. Tundo, D. J. Kippenberger, N. J. Politi, P. Klahn and J. H. Fendler “Redox Active Functionally Polymerized Surfactant Vesicles. Syntheses and Characterization” in J. Am. Chem. Soc. 1982, 104, pages 5352 to 5358, the entire contents of which are hereby incorporated by reference.

The concentration of the active ingredient(s) to be encapsulated or enclosed in the starting mixture can also vary within wide ranges, depending on the activity of the active ingredients in question. It is usually about 0.001 to about 50% by weight, preferably about 5 to 40% by weight, in particular about 25 to about 40% by weight, based on the starting mixture.

The active ingredient is generally in a form such that it is dissolved in the oil phase as organic carrier phase; in this case, the active ingredient is enclosed together with the oil phase. If the active ingredient to be enclosed or encapsulated is itself an oil phase, the use of a further oil phase is not obligatory; in this case, the active ingredient can thus be encapsulated or enclosed either on its own, i.e. without a diluent or as a pure substance, or else in a form dissolved in a further oil phase.

The active ingredients used according to the invention may be active ingredients of any type and nature. However, the active ingredients used should be as inert as possible under the reaction conditions and not adversely affect the course of the reaction.

Nonlimiting examples of active ingredients which can be used according to the invention are the following substances and substance mixtures: fragrances; oils, such as essential oils, perfume oils, care oils and silicone oils; pharmaceutically active substances, such as antibacterial, antiviral or fungicidal active ingredients; biogenic active ingredients; antioxidants; vitamins and vitamin complexes; enzymes and enzymatic systems; cosmetically active substances, such as, for example, deodorants, odor absorbers, antiperspirants, hair care agents and hair colorants, antidandruff agents, skin care agents or other substances which can be used for body care; UV light protection factors; self-tanning agents; preservatives, insect repellents; washing- and cleaning-active substances; biogenic active ingredients; dyes; oxidizing agents and bleaches; defoaming substances; amines; and mixtures of the active ingredients listed above.

The interfacial polymerization in step (b) produces ultra-thin layers at the phase boundary between oil (organic phase) and water, in particular induced by heat or suitable UV irradiation, colloidal aggregates forming at the start of the polymerization, which are then further crosslinked. This behavior is found with all of the reactions carried out. Rheological investigations have shown that a crosslinked system is obtained in which the elastic portions significantly outweigh the viscose portions. Furthermore, high limiting deformations were determined, which mirror an almost rubber-like behavior.

The use of free-radical polymerization initiators (polymerization starters) when carrying out step (b) is not obligatory, i.e. the preparation of the products according to the invention can take place with or without the use of a polymerization initiator. However, the use of a polymerization initiator drastically reduces the reaction times in some cases, which is particularly advantageous for the crosslinking of sensitive active ingredients at the phase interface.

When a polymerization initiator (polymerization starter) is used for carrying out the interfacial polymerization, the concentration of the polymerization initiator (polymerization starter) in the starting mixture can vary within wide limits. It is generally about 0.05 to about 0.5 mmol/l, preferably about 0.05 to 0.2 mmol/l, based on the starting mixture.

Suitable free-radical polymerization initiators are all compounds familiar to the person skilled in the art for this purpose. In this connection, it is possible to use initiators which dissolve in the organic phase and initiators which dissolve in the aqueous phase, but also initiators which are located at the phase interface and are thus interfacially active.

Examples of free radical starters which are soluble in the organic phase are azobisisobutyronitrile (AIBN), 2,2-dimethoxy-2-phenylacetophenone and benzoin methyl ether. Use of these initiators allows drastically reduced reaction times for the crosslinking at the phase interface to be achieved. The use of these initiators thus offers the possibility of starting a polymerization in a targeted manner at the interface.

Examples of free-radical starters which are soluble in the aqueous phase are persulfate salts (e.g. sodium persulfate) or transition metal sulfates (e.g. cerium(IV) sulfate). Initiators in the aqueous phase, such as, for example, persulfate salts dissolved in the aqueous phase, can “capture” organic monomers at the phase boundary which are produced by UV irradiation, and thus likewise accelerate the polymerization.

A further possibility of starting a polymerization in a targeted manner at the interface is to use an initiator system which comprises amphiphilic (surface-active, interface-active) substances, which brings with it the advantage that the interface-active initiators start, accelerate and stabilize the free-radical polymerization reaction directly at the interface. Such interface-active starters are also referred to as so-called “inisurfs”. These starter systems, too, effect a considerable shortening of the reaction or irradiation time, i.e. thus a reaction acceleration with the same degree of crosslinking. Examples of such inisurfs or interface-active, amphiphilic free-radical starters are reaction products which are synthesized from AIBN and nonionic emulsifiers (such as e.g.

Eumulgin® B1 [polyoxyethylene-12 cetylstearyl alcohol], Eumulgin® B2 [polyoxyethylene-20 cetylstearyl alcohol] and Eumulgin® B3 [polyoxyethylene-30 cetylstearyl alcohol] from Henkel).

As described above, the dispersion produced in step (a) may optionally comprise at least one suitable comonomer which is polymerized together with the monomer under the reaction conditions in step (b) of the method according to the invention, and forms the capsule network, i.e. the coating. The comonomer optionally used is preferably an interface-active (amphiphilic, surface-active) comonomer.

If the method according to the invention is carried out using such a comonomer, capsules, droplets or pellets of the same type are obtained which have increased stability toward shearing. In other words, the use of a comonomer effects an additional stability of the capsules, droplets or pellets produced and ensures a high degree of crosslinking.

If the method according to the invention is carried out using a comonomer, the comonomer concentration in the starting mixture is about 5 to about 40 mmol/l, preferably about 5 to about 20 mmol/l.

Comonomers suitable according to the invention are, in particular, chosen from acrylic acids and derivatives (e.g. tetraethylene glycol diacrylates, tetrapropylene glycol diacrylates and mixtures thereof); methacrylic acids and derivatives (e.g. ethylene glycol dimethacrylates, triethylene glycol dimethacrylates, tetrapropylene glycol dimethacrylates and mixtures thereof); diallylamines; and diallyl sulfides.

Examples of comonomers which can be used according to the invention are the following compounds: methacrylic acid, acrylic acid, diallylamine, diallyl sulfide, triethylene glycol dimethacrylate, tetrapropylene glycol dimethacrylate (e.g. Blemmer PDP 200®, sold by Nippon Oil & Fats Co., Ltd.), ethylene glycol dimethacrylate (e.g. Blemmer PDE 50®, sold by Nippon Oil & Fats Co., Ltd.), tetrapropylene glycol diacrylate (e.g. Blemmer ADP 200®, sold by Nippon Oil & Fats Co., Ltd.) and tetraethylene glycol diacrylate (e.g. Blemmer ADE 200®, sold by Nippon Oil & Fats Co., Ltd.).

Further comonomers suitable according to the invention are described in the article by B. Boutevin et al. “Comparative de la réaction de polymérisation en solution de monomères tensioactifs méthacryliques” in Eur. Polym. J., Vol. 32, No. 7, pages 821 to 825 (1996), the disclosure of which is hereby incorporated by reference.

Process step (b) can optionally be followed, in step (c), by separating off or isolating the polymer capsules, pellets or droplets containing an active ingredient obtained in step (b). The separation can be carried out by methods customary to the person skilled in the art, in which no excessively large shear forces are exerted onto the polymer capsules, pellets or droplets in order that they are not damaged. Separation methods suitable according to the invention are, for example, freeze drying (lyophilization) or spray-drying under gentle conditions.

Equally, however, it is possible to use the reaction mixture containing the inventive polymer capsules, pellets or droplets containing an active ingredient obtained in step (b) directly for the respective application, where appropriate following evaporation or stripping off of the dispersant(s).

The method according to the invention is thus suitable for the encapsulation or for the enclosure of active substances in polymer capsules, pellets or droplets with an ultra-thin diffusion-tight coating. The term “diffusion-tight” in this connection means that the ultra-thin coatings of the produced capsules, pellets or droplets are diffusion-tight toward the enclosed active ingredient, and release takes place only in a controlled and targeted manner via a suitable release mechanism (e.g. as a result of the targeted action of shear forces).

The method according to the invention thus permits an efficient production of polymeric capsules, pellets or droplets containing an active ingredient and having an ultra-thin coating whose contents (active ingredient) can be released in a targeted manner, in particular by mechanical destruction of the polymeric walls, e.g. by shearing.

The encapsulation or the enclosure prevents coagulation, agglomeration and uncontrolled diffusion of the enclosed active ingredients, and at the same time permits their controlled release (e.g. by shearing).

Thus, the polymer capsules, pellets or droplets produced also in accordance with the method according to the invention can be used as delivery systems for said active ingredients and thus ensure controlled release of these active ingredients at the desired site of use. For example, the capsules, pellets or droplets prepared by the method according to the invention are particularly suitable as delivery systems in the fields of cosmetics, pharmacy, adhesive application and/or detergents and cleaners.

The method according to the invention is thus suitable for the production of polymer capsules, pellets or droplets with ultra-thin coatings which are suitable as carrier matrix for active ingredients which are very diverse in nature. By the method according to the invention, it is possible to produce polymer capsules, pellets or droplets containing an active ingredient and having ultra-thin coatings.

The term “ultra-thin” in this connection means that in the ideal case monomolecular polymer layers or films form which surround the active ingredients to be encapsulated or enclosed. However, polymer capsules, pellets or droplets containing an active ingredient with a coating thickness/capsule diameter ratio of from about 1:5000 to about 1:5, preferably from about 1:1000 to about 1:10, in particular from about 1:500 to about 1:100, can usually be obtained. In this connection, the polymer capsules, pellets or droplets containing an active ingredient prepared in this way generally have average particle diameters of from about 50 nm to about 50,000 nm, preferably from about 100 nm to about 5000 nm, very particularly preferably from about 100 nm to 1000 nm.

The method according to the invention is thus suitable for the in situ encapsulation or for the in situ enclosure of active ingredients, which, when the interfacial polymerization is complete, are embedded into polymer capsules, pellets or droplets with an ultra-thin coating.

A further advantage of the capsules, pellets or droplets produced according to the invention is that they have a large charge potential toward the active ingredients to be enclosed or encapsulated.

In addition, through the choice of the production and reaction parameters (type, functionality and amount of the monomers; type, functionality and amount of the comonomers; type and amount of the active ingredients; type and amount of the polymerization initiators; reaction time under other reaction parameters, in particular irradiation time, wavelength and intensity, type and concentration of the oil phase; type and concentration of the aqueous phase; variation in the particle size within the dispersion etc.), it is possible to enable targeted control, a “tailoring”, so to speak, of the properties of the polymeric capsules, pellets or droplets produced. Through the choice of the production parameters it is possible to formulate and optimize the formulation of the microcapsules, micropellets or microdroplets for the respective application.

Using the method according to the invention it is possible to produce microcapsules, micropellets or microdroplets containing an active ingredient with considerably shortened reaction times. For this reason, the method according to the invention represents a novel and simple way of producing selectively effective delivery systems with a broad application profile for a large number of products, in particular for the fields of cosmetics and body care, pharmacy, adhesive application and/or detergents and cleaners.

The products produced by the method according to the invention are particularly suitable as encapsulation, transportation or administration vehicles, i.e. as delivery systems or carrier systems for a very wide variety of applications (for example for the fields of cosmetics and body care, for the pharmaceutical sector, for adhesive application and/or for use for the detergent and cleaner industry).

The delivery systems produced by the method according to the invention permit the controlled release of the enclosed or encapsulated active ingredients, meaning that they can be used at the desired site of use with maximum effect. In some circumstances, a certain depot effect can be utilized (e.g. for pharmaceutical applications). In this way, the polymer capsules, pellets or droplets containing an active ingredient provide an efficient method of controlling the release kinetics, which can be varied through the choice of production and reaction parameters used, as described above. The present invention thus also provides a method for the controlled release of active ingredients.

As described above, the coatings of the polymer capsules, pellets or droplets containing an active ingredient according to the invention, which comprise at least one active ingredient enclosed in a polymer matrix, include a polymer which is obtainable by free-radical interfacial polymerization of at least one interface-active monomer and optionally at least one comonomer. The polymeric capsule network formed in this way is stable for at least 4 weeks.

The active ingredient content in the polymer capsules, pellets or droplets according to the invention is about 1 to about 99% by weight, in particular about 10 to about 80% by weight, preferably about 50 to about 80% by weight, based on the total weight of the polymer capsules, pellets or droplets.

As described above, the active ingredient can here be present in dissolved form in the oil phase as organic carrier phase, i.e. be encapsulated together with the oil phase. According to a particular embodiment of the present invention, namely when the active ingredient to be enclosed or encapsulated is itself an oil phase, the active ingredient can be encapsulated or enclosed on its own, i.e. without a diluent or as a pure substance. However, in the event that the active ingredient to be enclosed or encapsulated is itself an oil phase, it is possible to dissolve the active ingredient in a further oil phase and to encapsulate it in the dissolved form together with the oil phase.

Further embodiments and variations of the present invention are immediately evident and realizable for the person skilled in the art upon reading the description without departing from the scope of the present invention.

The present invention is illustrated by reference to the working examples below, which, however, in no way limit the invention.

### WORKING EXAMPLES

The monomers listed in the table below were successfully tested for generating ultra-thin membranes at the interface.

| Sample | Interface-active monomer | Trade name |
|---|---|---|
| 1 | Trimethylolpropane triacrylate | Photomer ® 4006* |
| 2 | Trimethylolpropane ethoxylate | Photomer ® 4149* |
| | triacrylate | |
| 3 | Trimethylolpropane propoxylate | Photomer ® 4072* |
| | triacrylate | |
| 4 | Aliphatic urethane diacrylate | Photomer ® 6010* |
| 5 | Aliphatic urethane triacrylate | Photomer ® 6008* |
| 6 | Dimerdiol dimethacrylate | |
| 7 | Dodecanediol-1,12 dimethacrylate | |
| 8 | Lauryl allyl sulfosuccinate | TREM-LF-40 ®** |
| 9 | Dodecyl-15 EO acrylate | Blemmer ALE 800 ®*** |
| 10 | Diallylammonium dodecylsulfonate | |

*The products of the Photomer ® range are sold by Cognis GmbH Deutschland.
**TREM-LF-40 ® is sold by Cognis Corp., USA.
***Blemmer ALE 800 ® is sold by Nippon Oil & Fats Co., Ltd.

### Example 1

### Reaction Without Initiator System

As an example of the various reactions without an initiator system are listed here the conditions of the experiments with a number of monomers with dodecane as the organic phase.

The mixing ratio of the organic phase in this experimental series with water was in each case 1:5. All of the experiments were carried out at room temperature. For the experiments in other organic phases, the same concentrations were used.

Firstly, water and the organic phase including the monomer were treated using an Ultra-Turrax® to produce a stable emulsion which was then polymerized in accordance with the method according to the invention.

| | | | Monomer | | |
|---|---|---|---|---|---|
| | | | concen- | UV | |
| Experi- | | | tration | intensity | |
| ment | Monomer | Oil phase | (mmol/l) | (mW/m²) | Remarks |
| 1 | Photomer ® | Dodecane | 10 | 5 | Capsule |
| | 4006 | | | | network |
| | | | | | stable after 4 |
| | | | | | weeks |
| 2 | Photomer ® | Dodecane | 15 | 8 | Capsule |
| | 4072 | | | | network |
| | | | | | stable after 4 |
| | | | | | weeks |
| 3 | Photomer ® | Dodecane | 15 | 8 | Capsule |
| | 6010 | | | | network |
| | | | | | stable after 4 |
| | | | | | weeks |
| 4 | Photomer ® | Dodecane | 10 | 8 | Capsule |
| | 6008 | | | | network |
| | | | | | stable after 4 |
| | | | | | weeks |

### Example 2

### Reaction with Polymerization Initiator

The conditions for a reaction series with 2,2-dimethoxy-2-phenylacetophenone as initiator in dodecane as the organic phase are listed in the table below, where the monomer concentration (10 mmol/l) and the UV intensity were kept constant, and the irradiation time was varied. The initiator was used under these experimental conditions in the concentration range from 0.2 to 0.4 mmol/l.

| | | Initiator concentration | Irradiation time |
|---|---|---|---|
| Experiment | Monomer | (mmol/l) | (min) |
| 1 | Photomer ® 4006 | 0.2 | 15 |
| 2 | Photomer ® 4006 | 0.3 | 10 |
| 3 | Photomer ® 4149 | 0.2 | 12 |
| 4 | Photomer ® 4149 | 0.25 | 10 |
| 5 | Photomer ® 4149 | 0.3 | 9 |
| 6 | Photomer ® 4072 | 0.4 | 10 |

### Example 3A

### Production of an Interface-Active Polymerization Initiator Starting from Eumulgin® B1 and Azobisisobutyronitrile (AIBN)

0.2 mol of Eumulgin®B1, 0.1 mol of azobisisobutyronitrile (AIBN) and 650 g of toluene were mixed in a 1-1 stirred apparatus and cooled to 2° C. in a cryostat. The solution was then saturated with HCl gas with stirring. The mixture was then stirred overnight at 0° C. The mixture was poured onto an ice/water mixture, and the toluene phase was separated off and dried over sodium sulfate. Finally, the solvent was stripped off to dryness on a rotary evaporator. The finished initiator was stored in a refrigerator under nitrogen.

### Example 3B

### Production of an Interface-Active Polymerization Initiator Starting from Eumulgin® B2 and azobisisobutyronitrile (AIBN)

The procedure was as in Example 3A, except that 0.2 mol of Eumulgin® B2 was used instead of Eumulgin® B 1.

### Example 4

### Reaction with an Interface-Active Polymerization Initiator

As an example of the production of capsules by interfacial polymerization using interface-active initiators (“inisurfs”) according to the method of the invention, reactions of the interface-active monomer Blemmer ALE 800® with a starter of Eumulgin® B1 and AIBN and with a starter of Eumulgin® B2 and AIBN in the presence of orange oil dissolved in dodecane were carried out.

Polymerization by UV irradiation gave the capsules as a quark-like mass, from which the organic active ingredient phase (orange oil in dodecane) was again freed upon titration.

The table below gives the data from the reactions with the two abovementioned inisurfs. The monomer used was always Blemmer ALE 800®.

| | | Initiator | Irradiation |
|---|---|---|---|
| | | concentration | time |
| Experiment | Inisurf | (mmol/l) | (min) |
| 1 | Eumulgin ® B1 + AIBN | 0.1 | 15 |
| 2 | Eumulgin ® B1 + AIBN | 0.15 | 13 |
| 3 | Eumulgin ® B1 + AIBN | 0.2 | 12 |
| 4 | Eumulgin ® B2 + AIBN | 0.1 | 10 |
| 5 | Eumulgin ® B2 + AIBN | 0.15 | 9 |
| 6 | Eumulgin ® B2 + AIBN | 0.2 | 7 |

### Example 5

### Reaction with an Interface-Active Polymerization Initiator

The same experimental series as in the previous example was carried out again with the addition of the comonomer triethylene glycol dimethacrylate. This gave capsules of the same type which have increased stability toward shearing.

1. A method for producing polymer capsules, pellets or droplets containing an active ingredient and having an ultra-thin coating, in which
(a) firstly a dispersion is prepared which comprises at least one active ingredient to be encapsulated or enclosed and, starting from which, polymers can be formed by free-radical interfacial polymerization;
(b) then a heat-, plasma- or radiation-induced free-radical interfacial polymerization is carried out in the dispersion obtained in step (a), such that, in this way, an in situ encapsulation or an in situ enclosure of the at least one active ingredient into the polymer capsules, pellets or droplets produced by interfacial polymerization takes place; and
(c) finally the polymer capsules, pellets or droplets containing an active ingredient obtained in this way can, if required, be separated off.

2. The method as claimed in claim 1, characterized by the following steps:
(a) provision of a dispersion comprising:
at least one interfacially active monomer,
at least one active ingredient to be encapsulated or enclosed,
optionally at least one polymerization initiator,
optionally at least one comonomer,
optionally at least one polymerization accelerator,
aqueous phase and
oil phase;
(b) carrying out a heat-, plasma- or radiation-induced free-radical interfacial polymerization of the at least one interface-active monomer in the presence of the at least one active ingredient and optionally the at least one polymerization initiator, optionally the at least one comonomer and optionally the at least one polymerization accelerator at the phase interface between oil phase and aqueous phase, which results in an in situ encapsulation or an in situ enclosure of the at least one active ingredient;
(c) if required, separation of the polymer capsules, pellets or droplets containing an active ingredient obtained in this way off from the reaction mixture.

3. The method as claimed in claim 1 or 2, where the active ingredient is also the oil phase.

4. The method as claimed in claim 1 or 2, where the active ingredient is dissolved in the oil phase and/or in the aqueous phase.

5. The method as claimed in any of the preceding claims, where the interfacial polymerization is light-induced and the irradiation time is preferably about 5 to about 60 min at an irradiation intensity of from about 5 to about 30 mW/m² and at an irradiation maximum of about 254 nm.

6. The method as claimed in any of the preceding claims, where the reaction temperature for the interfacial polymerization is about 10° C. to about 100° C., preferably about 20 to about 50° C.

7. The method as claimed in any of the preceding claims, where the monomer concentration in the starting mixture is about 5 to about 60 mmol/l, preferably about 5 to about 30 mmol/l.

8. The method as claimed in any of the preceding claims, where the initiator concentration in the starting mixture is about 0.05 to about 0.5 mmol/l, preferably about 0.05 to about 0.2 mmol/l.

9. The method as claimed in any of the preceding claims, where the active ingredient concentration in the starting mixture is about 0.001 to about 50% by weight, preferably about 5 to about 40% by weight, in particular about 25 to about 40% by weight, based on the starting mixture.

10. The method as claimed in any of the preceding claims, where the dispersion time is about 0.5 to about 3 minutes.

11. The method as claimed in any of the preceding claims, where the active ingredient is chosen from the group of fragrances; oils, such as essential oils, perfume oils, care oils and silicone oils; pharmaceutically active substances, such as antibacterial, antiviral or fungicidal active ingredients; antioxidants; vitamins and vitamin complexes; enzymes and enzymatic systems; cosmetically active substances; washing- and cleaning-active substances; biogenic active ingredients; dyes; oxidizing agents and bleaches; defoaming substances; amines; and mixtures thereof.

12. The method as claimed in any of the preceding claims, where the interface-active monomer is chosen from the group of interface-active (meth)acrylates, succinates and sulfonates, and derivatives thereof.

13. The method as claimed in claim 12, where the interface-active monomer is chosen from the group of trimethylolpropane triacrylate, trimethylolpropane ethoxylate triacrylate, trimethylolpropane propoxylate triacrylate, aliphatic urethane diacrylates, aliphatic urethane triacrylates, dimerdiol dimethacrylate, dodecanediol-1,12 dimethacrylate, lauryl allyl sulfosuccinate, dodecyl-15 EO acrylate, dodecyl-15 EO methacrylate, octadecyl-15 EO methacrylate, octadecyl-15 EO acrylate, diallylammonium dodecylsulfonate, diallylsulfonium 2-hydroxydodecyl chloride, diallylsulfonium 2-hydroxytetradecyl chloride, diallylsulfonium 2-hydroxyhexadecyl chloride, polyethylene glycol monomethacrylate, polyethylene glycol monoacrylate, polypropylene glycol monomethacrylate, polypropylene glycol monoacrylate, polyethylene glycol polypropylene glycol monomethacrylate, polyethylene glycol polypropylene glycol monoacrylate and mixtures thereof.

14. The method as claimed in any of the preceding claims, where the polymerization initiator is chosen from the group of azobisisobutyronitrile (AIBN); reaction products of AIBN and nonionic emulsifiers, such as Eumulgin® B1, Eumulgin® B2 and Eumulgin® B3; benzoin methyl ether; 2,2-dimethoxy-2-phenylacetophenone; persulfates, such as sodium persulfate and transition metal sulfates, such as cerium(IV) sulfate.

15. The method as claimed in any of the preceding claims, where the comonomer is chosen from acrylic acids and derivatives, such as tetraethylene glycol diacrylates, tetrapropylene glycol diacrylates and mixtures thereof; methacrylic acids and derivatives, such as ethylene glycol dimethacrylates, triethylene glycol dimethacrylates, tetrapropylene glycol dimethacrylates and mixtures thereof; diallylamines; and diallyl sulfides.

16. The method as claimed in any of the preceding claims, where the polymer capsules, pellets or droplets which contain an active ingredient and have been prepared in this manner have a ratio of coating thickness to capsule diameter of from about 1:5000 to about 1:5, preferably from about 1:1000 to about 1:10, in particular from about 1:500 to about 1:100.

17. The method as claimed in any of the preceding claims, where the polymer capsules, pellets and droplets which contain an active ingredient and have been prepared in this way have average particle diameters of from about 50 nm to about 50,000 nm, preferably from about 100 nm to about 5000 nm, very particularly preferably from about 100 to 1000 nm.

18. The method as claimed in any of the preceding claims, where the polymer capsules, pellets or droplets which contain an active ingredient and have been prepared in this way have an active ingredient content of from about 1 to about 99% by weight, in particular from about 10 to about 80% by weight, preferably from about 50 to about 80% by weight, based on the total weight of the polymer capsules, pellets or droplets.

19. The method as claimed in any of the preceding claims for the encapsulation or for the enclosure of active ingredients in polymer capsules, pellets or droplets having an ultra-thin diffusion-tight coating.

20. A polymer capsule, pellet or droplet containing an active ingredient, obtainable by the method as claimed in any of claims 1 to 19.

21. A polymer capsule, pellet or droplet containing an active ingredient and which comprises at least one active ingredient enclosed in a polymer matrix and whose coating comprises a polymer obtainable by free-radical interfacial polymerization of at least one interface-active monomer and optionally at least one comonomer.

22. The polymer capsule, pellet or droplet containing an active ingredient as claimed in claim 21, characterized by a ratio of coating thickness to capsule diameter of from about 1:5000 to about 1:5, preferably from about 1:1000 to about 1:10, in particular from about 1:500 to about 1:100.

23. The polymer capsule, pellet or droplet containing an active ingredient as claimed in claim 21 or 22, characterized by an average particle diameter of from about 50 nm to about 50,000 nm, preferably from about 100 nm to about 5000 nm, very particularly preferably from about 100 nm to about 1000 nm.

24. The polymer capsule, pellet or droplet containing an active ingredient as claimed in any of claims 21 to 23, characterized by an active ingredient content of from about 1 to about 99% by weight, in particular from about to about 80% by weight, preferably from about 50 to about 80% by weight, based on the total weight of the polymer capsule, pellet or droplet.

25. The polymer capsule, pellet or droplet containing an active ingredient as claimed in any of claims 20 to 24, characterized in that it is diffusion-tight.

26. The polymer capsule, pellet or droplet containing an active ingredient as claimed in any of claims 20 to 25, characterized in that the capsule network remains stable for at least 4 weeks.

27. The use of the polymer capsules, pellets or droplets containing an active ingredient as claimed in any of claims 20 to 26 for use as delivery systems, in particular in the field of cosmetics and body care, pharmacy, adhesive application and/or detergents and cleaners.

28. The use as claimed in claim 27 for the controlled release of active ingredients.
